(19) United States
(12) Patent Application Publication
(10) Pub. No.: US 2006/0061818 A1
(43) Pub. Date: Mar. 23, 2006

(54) Image-forming device having printout page-editing function and method thereof

(75) Inventors: Alexei Zavitaev, Suwon-si (KR); Oleksandr Krykun, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/232,879

(22) Filed: Sep. 23, 2005

(30) Foreign Application Priority Data
Sep. 23, 2004 (KR) 10-2004-0076394

(51) Int. Cl. G06F 3/12

(52) U.S. Cl. 358/1.15

(57) ABSTRACT

An image-forming device having a printout page-editing function and a method thereof is provided, wherein the printout page-editing function includes an interface unit for receiving the plurality of images and information on the plurality of images from the external device, a page-editing unit for editing pages for printout by arranging the plurality of images in an order that requires the minimum number of pages for printout in which the plurality of images are printed according to the information, and a printer engine for printing the plurality of images arranged on the pages for printout output from the page-editing unit. Accordingly, embodiments of the present invention edit the pages for printout to arrange as many images as possible in one page for printout, thereby saving pages during printout.

### CROSS-REFERENCE TO RELATED APPLICATIONS

This application claims the benefit under 35 U.S.C. §119(a) of Korean Patent Application No. 10-2004-0076394, filed in the Korean Intellectual Property Office on Sep. 23, 2004, the entire disclosure of which is incorporated herein by reference.

### BACKGROUND OF THE INVENTION

1. Field of the Invention

The present invention relates to an image-forming device having a printout page edit function and a method thereof. More particularly, the present invention relates to an image-forming device having a printout page edit function and a method thereof that is capable of determining and printing optimal layouts for a plurality of images sent from peripherals or external devices.

2. Description of the Related Art

In general, image-forming devices such as printers and multi-function devices send and receive data to and from information-processing devices such as computers through serial or parallel lines, receive printout data from the information-processing devices, and print the data on sheets of paper.

More recently, technologies for image-forming devices have been developed to be capable of providing other diverse functions, simplifying usage, and saving expenses to meet more user-friendly and cost-reducing demands.

With conventional apparatuses, if a user wants to print image files stored in a peripheral such as a digital camera, the user connects the digital camera to an information-processing device such as a computer, turns on the information-processing device to load an application program and receive image data from the digital camera, and selects a printout command in the application program to send the data to the image-forming device through a printer driver for printout.

However, such a conventional method causes inconvenience and wastes time and resources due to complicated procedures, such as turning on the information-processing device, loading an application program, generating printout data, sending printout data to the image-forming device, and so on.

Recently, there has emerged a method of connecting a peripheral such as a digital camera to an image-forming device through a connection port provided with the image-forming device, and directly receiving image data from a peripheral for printout, without the complicated procedures as described above.

If an image-forming device directly receives image data from a peripheral such as a digital camera, the procedures for connecting the information-processing device, turning on the information-processing device, loading an application program, generating printout data, sending printout data to the image-forming device, and so on, are omitted, thereby increasing users' convenience.

However, if the image-forming device directly receives and prints image data sent from a peripheral such as a digital camera, the image-forming device forms and prints pages in an order of image data transmission, regardless of a page size.

That is, the conventional image-forming device creates one printout page per image in the order of data transmission from the digital camera, prints the printout pages on sheets of paper in order, or arranges image data having various sizes in the order of the data transmission until each page is filled with the data, and prints the data-arranged pages.

Accordingly, the conventional method has problems of paper waste and does not allow image data to be properly arranged on printout pages depending on data sizes, as the conventional method forms printout pages in the order of data transmissions regardless of image data sizes.

Accordingly, a need exists for a system and method for determining and printing optimal layouts for a plurality of images sent from peripherals or external devices.

### SUMMARY OF THE INVENTION

The present invention has been developed in order to substantially solve the above and other problems associated with the conventional arrangement. An aspect of the present invention is to provide an image-forming device having a printout page-editing function and a method thereof that is capable of editing image data sent from a peripheral to fit into pages for printout so as to prevent paper waste during printout.

The foregoing and other objects and advantages are substantially realized by providing an image-forming device having a printout page-editing function, comprising an interface unit connected to an external device for receiving the plurality of images and information on the plurality of images from the external device, a page-editing unit for editing pages for printout by arranging the plurality of images in an order that requires the minimum number of pages for printout in which the plurality of images are printed according to the information, and a printer engine for printing the plurality of images depending on the pages for printout that are output from the page-editing unit.

Preferably, the information contains data regarding sizes of the plurality of images.

Further, the page-editing unit preferably uses optimization algorithms to edit the pages for printout so that the total number of pages is reduced to a minimum value.

Further, the external device is preferably comprised of a digital camera.

Preferably, the image-forming device further comprises a control panel comprising a hot-key for generating a control signal for operating the page-editing unit.

The foregoing and other objects and advantages are also substantially realized by providing a printout page-editing method for an image-forming device connected to an external device storing images and for receiving a plurality of images from the external device, comprising steps of receiving information on the plurality of images from the external device, editing pages for printout by arranging the plurality of images in an order that requires the minimum number of pages for printout in which the plurality of images are printed according to the information, receiving the plurality of images in the order of the edited pages for printout, and printing the plurality of images in the order of the edited pages for printout.

Further, the information-receiving step preferably comprises the steps of receiving a printout request message from the external device, sending a printout approval message and an information-requesting message to the external device, and receiving the information from the external device.

Further, the step of receiving the plurality of images preferably comprises the steps of requesting from the external device a first image contained in a first page for printout depending on the edited pages for printout, and sending the first image from the external device in response to the request.

Preferably, the step of receiving the plurality of images comprises the step of requesting the external device to send a second image contained in the first page for printout if the first image is completely sent.

### BRIEF DESCRIPTION OF THE DRAWINGS

The above aspects and features of the present invention will become more apparent by describing exemplary embodiments of the present invention with reference to the accompanying drawings, in which:

FIG. 1A and FIG. 1B are perspective views for showing circumstances in which an image-forming device having a printout page-editing function according to an embodiment of the present invention can be applied;

FIG. 2 is a block diagram for showing an exemplary image-forming device and an exemplary peripheral according to an embodiment of the present invention;

FIG. 3 is a view for illustrating operations of a control panel of the image-forming device of FIG. 2 according to an embodiment of the present invention;

FIG. 4A and FIG. 4B are views for illustrating operations of an image-forming device based upon an arbitrary order of transmissions;

FIG. 4C is a view for illustrating exemplary operations of the image-forming device of FIG. 2 according to an embodiment of the present invention;

FIG. 5 is a flow chart for illustrating exemplary operations of the image-forming device having a printout page-editing function according to an embodiment of the present invention; and

FIG. 6 is a view for illustrating an exemplary communication process of the image-forming device with the peripheral according to an embodiment of the present invention.

Throughout the drawings, like reference numerals will be understood to refer to like parts, components and structures.

### DETAILED DESCRIPTION OF THE EXEMPLARY EMBODIMENTS

Hereinafter, exemplary embodiments of the present invention will be described in more detail with reference to the drawings.

In exemplary embodiments of the present invention, an image-forming device is connected to a peripheral having a memory unit therein, and directly receives image data from the peripheral, edits a printout page in such a way that the number of image data arranged in the printout page is maximized depending on information of image data size, and prints the edited page on sheets of paper.

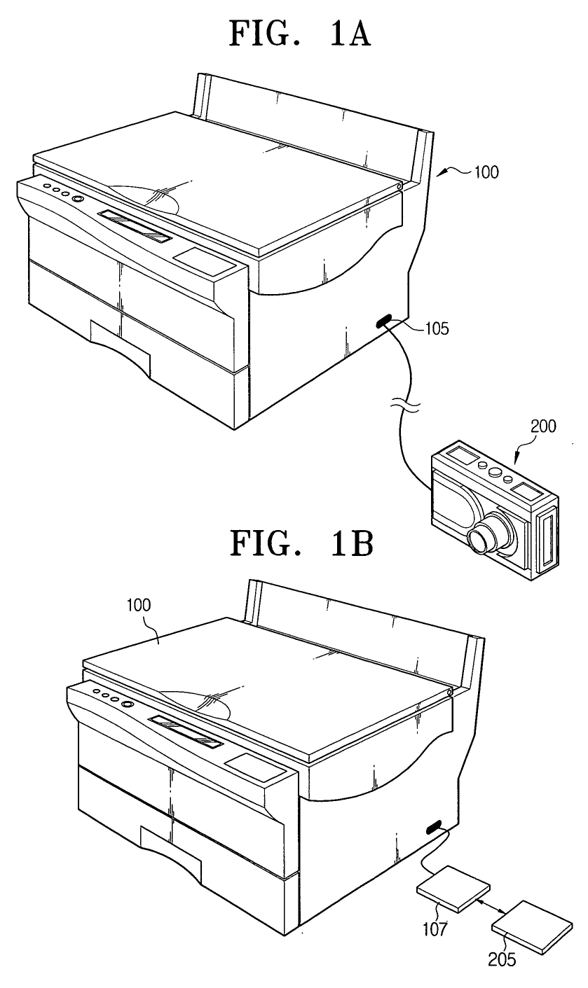

FIG. 1A is a view for showing circumstances in which the image-forming device having a printout page-editing function can be used according to an embodiment of the present invention.

In FIG. 1A, the image-forming device 100 connects to a peripheral 200 through a connection port 105 so as to enable data communications with the peripheral 200. That is, the image-forming device 100 connects to the peripheral 200, and receives and prints data stored in the peripheral 200 through a communication process of receiving a printout operation request from the peripheral, receiving information for printout operations, and so on.

In FIG. 1A, a digital camera is shown for example, but embodiments of the present invention can be applied to any number of peripherals that are capable of carrying out data communications with image-forming devices through various connection ports thereof to request plural printout jobs. However, for purposes of the following explanation, a digital camera is used as an exemplary peripheral, but is not limited thereto.

FIG. 1B is a view for showing yet other circumstances in which an image-forming device having a printout page-editing function is used according to an embodiment of the present invention.

In FIG. 1B, the image-forming device 100 is connected to the memory unit 205 through a card reader 107. The memory unit 205 may be comprised of a Compact Flash(CF)I, CF-type II (Microdrive), Smart Media Card (SMC), Multimedia Card (MMC), Secure Digital Memory Card (SD), Memory Stick (MS), and so on, and the card reader 107 supports such a memory unit and interfaces the image-forming device 100 and the memory unit 205.

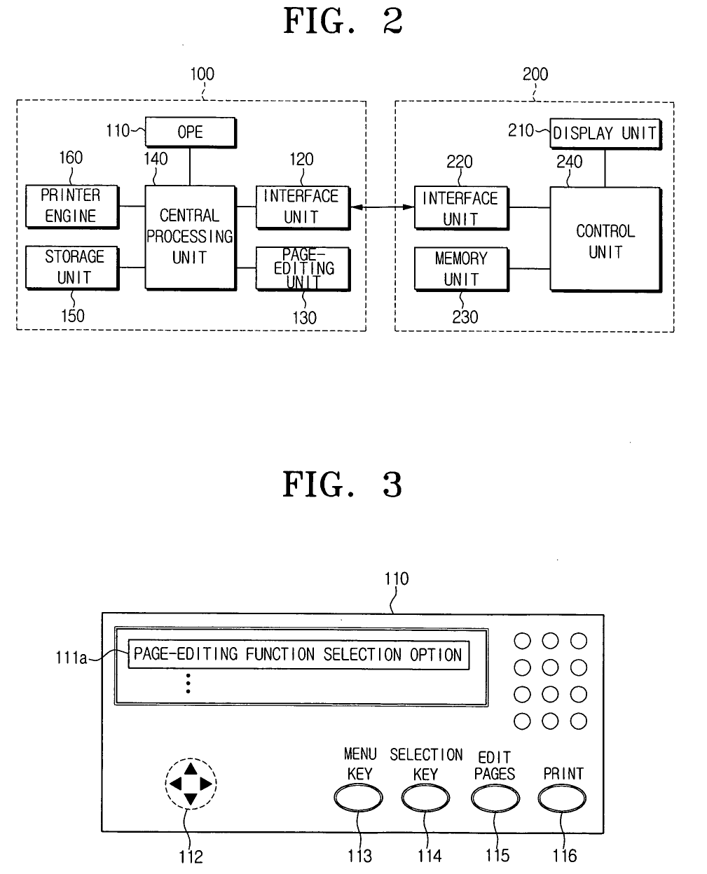

FIG. 2 is a block diagram for showing an exemplary image-forming device 100 and an exemplary digital camera 200 according to an embodiment of the present invention. In the illustrated image-forming device 100 and the digital camera 200, FIG. 2 shows only blocks for carrying out a printout page-editing function, and does not show the remaining blocks of each for purposes of simplifying the following explanation.

The image-forming device 100, which can be located on a network, comprises a control panel (OPE) 110, an interface unit 120, a page-editing unit 130, a central processing unit 140, a storage unit 150, and a printer engine 160.

FIG. 3 is a view for illustrating operations of a control panel 110 of the image-forming device 100 of FIG. 2 according to an embodiment of the present invention. As shown in FIG. 3, the control panel 110 comprises a plurality of numeral and function keys for controlling the image-forming device 100, and an LCD for displaying an operation status of the image-forming device 100. For example, the control panel 110 comprises a menu key 113 for selecting functions of the image-forming device, a selection key 114 for carrying out a function set by using the menu key 113, a page editing hot key 115 for selecting a printout page-editing function according to an embodiment of the present invention, and so on. A description of the menu key 113, selection key 114, and page editing hot key 115 for the printout page-editing function is provided in greater detail below. The control panel 110 applies a control signal generated by a user's key manipulations of the numeral keys and function keys to the central processing unit 140.

The interface unit 120 interfaces a peripheral such as a digital camera 200 and the central processing unit 140, receives data from the peripheral, or sends data from the image-forming device 100 to the peripheral.

The page-editing unit 130 edits a printout page in order to maximize the number of images included in one page by using any number of optimization algorithms, described in greater detail below, depending on information regarding sizes and number of printout images, and the like. The operations of the page-editing unit 130 are described in greater detail below.

The central processing unit 140 controls the operations of the image-forming device 100 according to a control signal applied from the control panel 110. For example, if the printout page-editing function is selected from the control panel 110 and a corresponding control signal is applied to the central processing unit 140, the central processing unit 140 communicates with a peripheral device through the interface unit 120, generates data to be sent to the peripheral, interprets various data sent from the peripheral, sends necessary information to the page-editing unit 130, and controls the page-editing unit 130 to control necessary operations. Further, the central processing unit 140 processes images sent for printout from the peripheral into a format required by the image-forming device 100, and temporarily stores the processed images in the storage unit 150 or generates data for printout based on printout page layouts output from the page-editing unit 130, and controls the printer engine 160 to print the created pages on sheets of paper.

The storage unit 150 comprises a non-volatile memory for storing various control programs for operating the image-forming device 100, and a volatile memory for storing data occurring during operations of the image-forming device 100 and detailed information on the data. For example, the volatile memory temporarily stores data for printout that is received from a peripheral through the network interface unit 120 and various data received from the peripheral. Further, the non-volatile memory stores information on various protocols necessary for data communications with peripherals.

The printer engine 160 prints data stored in the storage unit 150 according to a printout command input from the central processing unit 140, or arranges images sent from peripherals into pages for printout according to printout page layouts generated from the page-editing unit 130 and prints the pages created from the central processing unit 140.

The digital camera 200 is shown and described as a peripheral in embodiments of the present invention. The digital camera 200 comprises a display unit 210 for displaying captured images, an interface unit 220 for interfacing for data communications with the image-forming device 100, a memory unit 230 for storing images, and a control unit 240 for controlling the operations of the digital camera 200. Further, the digital camera 200 is provided with any number of other components, such as those provided for taking pictures of objects, but the remaining components are not shown for purposes of simplifying the following explanations.

The display unit 210 may comprise a STN-LCD which is a popular Liquid Crystal Display device, a TFT-LCD which is a Thin-Film Transistor Liquid Crystal Display device having clear image quality and excellent brightness, a UFB-LCD which has been exclusively developed by Samsung Electronics Ltd., or a TFD-LCD which is a Thin-Film Diode Liquid Crystal Display device developed by Seiko-Epson corporation of Japan. Preferably, the TFT-LCD is used to comprise the display unit 210. The display unit 210 is generally disposed on the rear side of the digital camera 200, and displays a target object for view or displays a captured image.

The memory unit 230 may comprise a memory stick as an external memory unit and a memory card, both of which can be detachably mounted to the digital camera 200, and so forth. The memory unit 230 stores images captured by the digital camera 200.

Further, the interface unit 220 of the digital camera 200 sends data sent from the control unit 240 to the interface unit 120 of the image-forming device 100, and sends data sent from the interface unit 120 of the image-forming device 100 to the control unit 240. Thus, if a printout request message generated by the control unit 240 of the digital camera 200 is sent and the image-forming device 100 approves the printout request, the printout information and images are sent in order of approval through the interface unit 220 of the digital camera 200.

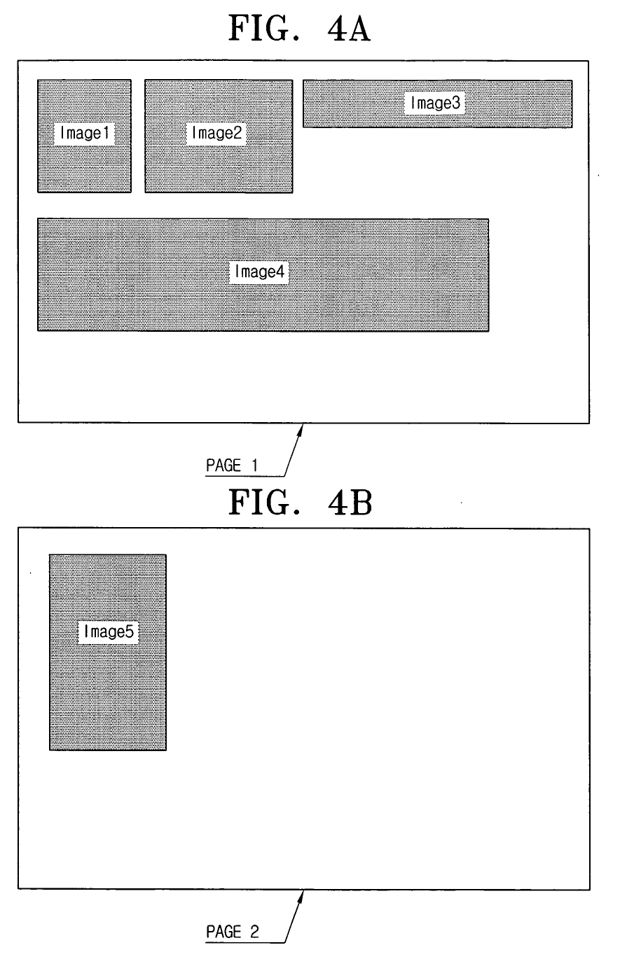

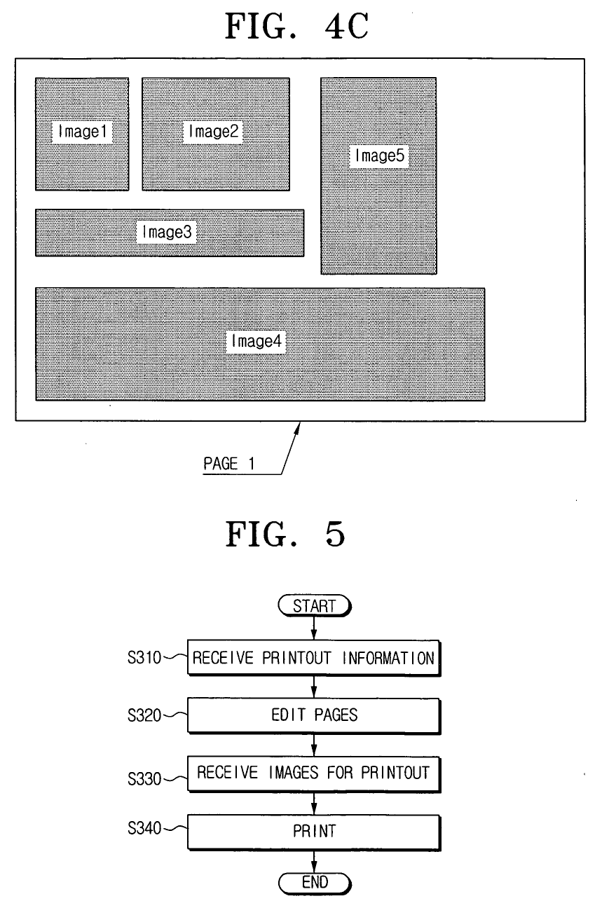

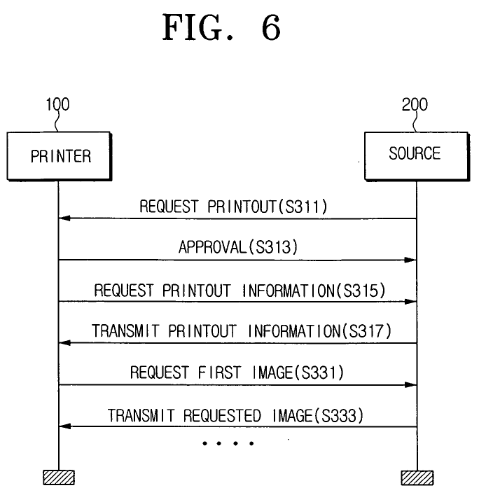

A description will now be made in greater detail of exemplary operations of an image-forming device having a printout page-editing function, which is structured as above, with reference to FIG. 3 to FIG. 6. FIG. 4A and FIG. 4B are views for illustrating operations of an image-forming device based upon an arbitrary order of transmissions, FIG. 4C is a view for illustrating exemplary operations of the image-forming device of FIG. 2, FIG. 5 is a flow chart for illustrating exemplary operations of the image-forming device having a printout page-editing function, and FIG. 6 is a view for illustrating an exemplary communication process of the image-forming device with the peripheral.

In the following example, two ways are described for a user to choose the printout page-editing function from the control panel 110. In FIG. 3, a user presses the menu key 113 of the control panel 110. If the page-editing function selection option 111a is displayed on the LCD display, the user presses the selection key 114 to choose the desired option. Alternately, the user can simply press the page-editing hot-key 115 for selecting the printout page-editing function provided on the control panel 110 so as to select the printout page-editing function.

Thus, the image-forming device 100 carries out the printout page-editing function. Referring now to the method of FIG. 5, if the central processing unit 140 of the image-forming device 100 receives and approves a printout request message from the peripheral 200 through the interface unit 120, the image-forming device 100 receives printout information from the peripheral 200 at step (S310) through a predetermined communication process which is described in greater detail below. The printout information comprises a list of images for printout and sizes of the images for printout.

In FIG. 6, an exemplary communication process for receiving the printout information of step (S310) is shown in greater detail. The process comprises steps that send a printout request from the digital camera 200 to the image-forming device 100 at step (S311), send an approval message to the digital camera 200 if the central processing unit 140 can carry out the sent request when checking the status of the image-forming device 100 according to the printout request sent from the digital camera 200 at step (S313), and send a message requesting the printout information on images for printout at step (S315). The digital camera 200 then sends the printout information comprising a list of images for printout, the number of the images for printout, and the sizes of the images for printout to the image-forming device 100 at step (S317). Steps (S331) and (S333) are described in greater detail below.

Returning to FIG. 5, the central processing unit 140 provides the received printout information to the page-editing unit 130, and the page-editing unit 130 outputs layouts for printout pages by using an optimization algorithm, and edits the printout pages at step (S320). The page-editing unit 130 may use any number of optimization algorithms, such as Simulated Annealing, Generic Algorithm, Local Search Methods, and so on, which are well-known to those skilled in the art as optimization algorithms.

The Simulated Annealing method is a kind of Monte Carlo Method for determining polynomial expressions of an N-body system, which is an algorithm for obtaining elements for reaching the least energy state of an entire system, for example, when metal is deformed under high temperatures during the annealing process in which the entire system reaches its thermodynamic equilibrium state as temperatures are slowly lowered, based on liquid freezing or metal recrystalization methods. More recently, the algorithm is widely applied to other fields for obtaining optimized approximate values.

Further, the Generic Algorithm is an algorithm for calculating a new population by applying certain conditions to a solution set called a ‘population’, that is, for calculating a solution set of an ‘optimal population’ by repeating calculations of the new population until reaching a target value of the number of people or an optimal population, based on Darwin's theory of evolution.

Further, the Local Search Methods use algorithms based on Solis-Wets optimization algorithms for calculating optimal values in a search space satisfying predetermined constraint elements, and which are widely applied to various sectors such as pattern classifications, filter designs, and so on.

Accordingly, the page-editing unit 130 sets the sizes of paper and the sizes and number of images for printout as constraint elements, calculates a minimum value for the number of pages for printout as a solution satisfying the constraint element, and obtains polynomial expressions for calculating each image location on each page when the number of pages for printout becomes a minimum value. Thus, the calculated minimum value for the polynomial expressions corresponds to a method for arranging individual images in order to minimize the number of pages for printout. However, in reality, it is not easy to obtain the minimum value satisfying the polynomial expressions, and it is not desirable to waste resources in order to obtain such a minimum value. Therefore, it is desirable to obtain an optimized approximate value nearest to the minimum value by using the above optimization algorithms.

As stated above, when the page-editing unit 130 determines the locations of individual images, as well as the layouts of pages for printout, the page-editing unit 130 creates a list of images in an order for printout. The central processing unit 140 then requests the digital camera 200 to send the images in the order of the list of images and receives the images at step (S330) through a communication process described in greater detail below.

In FIG. 4A and FIG. 4B, if the page-editing unit 130 creates pages for printout in an order of arbitrary transmissions of images from the digital camera 200 instead of editing pages for printout, the first to fourth images are printed on the first page, and the fifth image is printed on the second page, which creates paper waste, as well as creating unevenly arranged image locations on the pages for printout. However, FIG. 4C shows a layout of a page for printout that is determined by the page-editing unit 130 by using the printout page-editing function according to an embodiment of the present invention. In FIG. 4C, it can be seen that the printout images are properly arranged in one page, without reducing or enlarging their sizes, and having a good layout on the page for printout. Also, as one page is used, paper is saved during printout. In the example of FIG. 4C, images according to the determined layouts of pages for printout are listed in an order of the first, second, third, fifth, and fourth images, which varies from the order of images listed for printout in a list of images sent from the digital camera 200 at a first time.

In FIG. 6, the communication process for receiving images for printout is illustrated, wherein the central processing unit 140 of the printer 100 sends a message to the digital camera 200 requesting the first image to be sent in the order of the list of images according to the layouts for printout pages determined by the page-editing unit 130 at step (S331). The source, or digital camera 200, then sends the requested first image at step (S333). Next, the central processing unit 140 requests the second images, and the digital camera 200 receiving the request sends the second image, and, if all of the images for printout are completely sent, the communication process ends.

Embodiments of the present invention provide a method in which the image-forming device 100 requests the digital camera 200 to send images in an order matching that of a list of images for printout output from the page-editing unit 130, and the digital camera 200 sends the images as a response to the request. However, in another embodiment, the present invention can provide a method in which, if a list of images output from the page-editing unit 130 is sent to the digital camera 200 in an order, the digital camera 200 sends the images to the image-forming device 100 in an order with reference to the list of images.

Returning to FIG. 5, the central processing unit 140 then generates data for printout, which can be recognized by the printer engine 160, relating to the pages for printout having a layout for images received in order, wherein the images are arranged on each page according to the layout determined by the page-editing unit 130, and sends the data to the printer engine 160 to print the data on sheets of paper at step (S340).

In yet another embodiment of the present invention as shown in FIG. 1B, the image-forming device 100 is connected to the memory unit 205 through the card reader 107, and receives images stored in the memory unit 205. In this example, the communication process is not carried out as in the above exemplary embodiments, but the central processing unit 140 of the image-forming device 100 stores the images read from the memory unit 205 in the storage unit 150, and sends a list of images and the sizes of the images to the page-editing unit 130. The page-editing unit 130 arranges the images for printout, edits the pages for printout, determines a layout for each page for printout, and generates data for printout relating to each page according to the determined layout, so that the printer engine 160 can print the data for printout.

As stated above, embodiments of the present invention can edit pages for printout in order for as many images as possible of a plurality of images received from the image-forming device, to be arranged in one page, thereby saving paper for printout.

Further, embodiments of the present invention automatically edit pages for printout, so that the images are properly located without requiring a user to edit pages for printout one by one through the information-processing device or the image-forming device.

The foregoing embodiments and advantages are merely exemplary, and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. An image-forming device having a printout page-editing function wherein the image-forming device is connected to an external device storing images and receives a plurality of images from the external device, comprising:
an interface unit for receiving the plurality of images and information on the plurality of images from the external device;
a page-editing unit for editing pages for printout by arranging the plurality of images in an order that requires the minimum number of pages for printout in which the plurality of images are printed according to the information; and
a printer engine for printing the plurality of images arranged on the pages for printout based upon an output from the page-editing unit.

2. The image-forming device as claimed in claim 1, wherein the information comprises data regarding sizes of the plurality of images.

3. The image-forming device as claimed in claim 1, wherein the page-editing unit is configured to execute one or more optimization algorithms to edit the pages for printout resulting in a minimum number of total pages.

4. The image-forming device as claimed in claim 1, wherein the external device is comprised of a digital camera.

5. The image-forming device as claimed in claim 1, further comprising:
a control panel comprising a hot-key for generating a control signal for operating the page-editing unit.

6. A printout page-editing method for an image-forming device connected to an external device storing images and for receiving a plurality of images from the external device, comprising steps of:
receiving information on the plurality of images from the external device;
editing pages for printout by arranging the plurality of images in an order that requires the minimum number of pages for printout in which the plurality of images are printed according to the information;
receiving the plurality of images in the order of the edited pages for printout; and
printing the plurality of images in the order of the edited pages for printout.

7. The printout page-editing method as claimed in claim 6, wherein the information-receiving step comprises the steps of:
receiving a printout request message from the external device;
sending a printout approval message and an information-requesting message to the external device; and
receiving the information from the external device.

8. The printout page-editing method as claimed in claim 6, wherein the step of receiving the plurality of images comprises the steps of:
requesting from the external device a first image contained in a first page for printout based on the edited pages for printout; and
sending the first image from the external device in response to the request.

9. The printout page-editing method as claimed in claim 8, wherein the step of receiving the plurality of images comprises the step of:
requesting the external device to send a second image contained in the first page for printout if the first image is completely sent.

10. The printout page-editing method as claimed in claim 6, wherein the information comprises data regarding sizes of the plurality of images.

11. The printout page-editing method as claimed in claim 6, wherein the page-editing step comprises the step of:
executing one or more optimization algorithms to edit the pages for printout resulting in a minimum number of pages.

12. A computer program embodied on a computer-readable medium for printout page-editing for an image-forming device connected to an external device storing images and for receiving a plurality of images from the external device, comprising:
a first set of instructions for controlling an image forming device to receive information on the plurality of images from the external device;
a second set of instructions for controlling the image forming device to edit pages for printout by arranging the plurality of images in an order that requires the minimum number of pages for printout in which the plurality of images are printed according to the information;
a third set of instructions for controlling the image forming device to receive the plurality of images in the order of the edited pages for printout; and
a fourth set of instructions for controlling the image forming device to print the plurality of images in the order of the edited pages for printout.

13. The computer program embodied on a computer-readable medium as claimed in claim 12, wherein the first set of instructions comprises:
a set of instructions for controlling the image forming device to receive a printout request message from the external device;
a set of instructions for controlling the image forming device to send a printout approval message and an information-requesting message to the external device; and
a set of instructions for controlling the image forming device to receive the information from the external device.

14. The computer program embodied on a computer-readable medium as claimed in claim 12, wherein the third set of instructions comprises:
a set of instructions for controlling the image forming device to request from the external device a first image contained in a first page for printout based on the edited pages for printout;
a set of instructions for controlling the external device to send the first image from the external device in response to the request; and
a set of instructions for controlling the image forming device to request the external device to send a second image contained in the first page for printout if the first image is completely sent.

15. The computer program embodied on a computer-readable medium as claimed in claim 12, further comprising:
an optimization algorithm to edit the pages for printout resulting in a minimum number of pages.
